(19) United States
(12) Patent Application Publication
(10) Pub. No.: US 2022/0061589 A1
(43) Pub. Date: Mar. 3, 2022

(54) ATTACHMENT FOR PELLET GRILL HOPPER AND METHODS OF USE THEREOF

(71) Applicants: Sean Kristopher Dotson, St. Peters, MO (US); Bryan William Dotson, St. Peters, MO (US)

(72) Inventors: Sean Kristopher Dotson, St. Peters, MO (US); Bryan William Dotson, St. Peters, MO (US)

(21) Appl. No.: 17/459,893

(22) Filed: Aug. 27, 2021

Related U.S. Application Data
(60) Provisional application No. 63/070,881, filed on Aug. 27, 2020.

(51) Int. Cl. A47J 37/07; B33Y 80/00; F24B 13/04

(52) U.S. Cl. CPC A47J 37/0786; F24B 13/04; B33Y 80/00

(57) ABSTRACT

The present disclosure relates to an attachment for a pellet grill hopper.

### CROSS-REFERENCE TO RELATED APPLICATIONS

The present disclosure claims priority to U.S. Provisional Application No. 63/070,881, filed Aug. 27, 2020 entitled “The System and Method of Emptying out the Hopper of a Pellet Grill by using a System to Control Pellet Flow Into a Designated Container,” the entirety of which is incorporated herein by reference.

### FIELD OF THE DISCLOSURE

The present disclosure is related to the field of pellet grills, particularly to devices and methods useful for removing pellets from pellet grill hoppers.

### BACKGROUND

Pellet grills operate by using different combinations of wood pellets to generate heat and smoke inside the grill. The pellets are stored in a hopper and are transferred into the grill by an auger.

Consumers replace pellets in the hopper regularly both for safety reasons and to create new flavors. This requires the consumer to remove the pellets from the hopper and store them in a weather-tight container. The most common way to remove the pellets is by opening a clean-out door located on the hopper, which allows the pellets to fall out of the hopper. The pellets fall out of the hopper in a sporadic and uncontrolled manner.

What is needed is a device that controls the flow of pellets from the hopper.

### SUMMARY OF THE DISCLOSURE

Disclosed herein is a pellet grill attachment useful for removing pellets from a pellet grill hopper. The pellet grill attachment includes a front wall panel comprising a left end, a right end, and a bottom end; a left wall panel comprising a front end, a flange end that is opposite the front end, and a bottom end, wherein the front end of the left wall panel is attached to the left end of the front wall panel; a right wall panel comprising a front end, a flange end that is opposite the front end, and a bottom end, wherein the front end of the right wall panel is attached to the right end of the front wall panel; and a bottom wall panel comprising an aperture, wherein the bottom panel is attached to each of the bottom ends of the front wall panel, the left wall panel, and the right wall panel. Each of the flange ends of the left wall panel and the right wall panel comprises a flange extending outward from the wall panel and an attachment mechanism that is operable to attach to a pellet grill hopper. The pellet grill attachment may be 3D printed or injection molded. The bottom panel may further include sloped edges. The pellet grill attachment may comprise plastic, metal, wood, ceramic, composite, or combinations thereof. The flanges of each of the left wall panel and the right wall panel may extend perpendicularly outward from the wall panel.

The pellet grill attachment may be operable to reversibly or permanently attach to the pellet grill hopper. When reversibly attachable, the attachment mechanism may include at least one screw, at least one magnet, double-sided tape, at least one pin, hook and loop fasteners, hooks, adhesives, or combinations thereof. When permanently attachable, the attachment mechanism may include at least one nail, welding, adhesives, or combinations thereof.

Further disclosed herein is a method for removing unused pellets from a pellet grill hopper. The method may include providing a pellet grill hopper, wherein the pellet grill hopper comprises a clean-out door; attaching the pellet grill attachment described herein to the pellet grill hopper; positioning a storage container below the pellet grill attachment; and opening the clean-out door to release the pellets contained in the pellet grill hopper.

### BRIEF DESCRIPTION OF THE FIGURES

FIG. 1 is view of the pellet grill attachment as attached to a pellet grill hopper.

FIG. 2 is a broader view of the pellet grill attachment as attached to a pellet grill hopper.

FIG. 3 is an overhead view of the pellet grill attachment.

FIG. 4 is a side view of the pellet grill attachment, showing the flange ends of the left and right side wall panels.

FIG. 5 is a perspective view of the pellet grill attachment.

FIG. 6 is a side view of the pellet grill attachment from the right side wall panel.

FIG. 7 is a perspective view of a pellet grill attachment with a curved chute.

FIG. 8 is a cutaway view of a pellet grill attachment with a curved chute.

FIG. 9 is a cutaway view of a pellet grill attachment with a curved chuted in a retracted position.

### DETAILED DESCRIPTION

It is to be understood that this disclosure is not limited to the particular methods, compositions, or materials specified herein, but is extended to equivalents thereof as would be recognized by those ordinarily skilled in the relevant arts. It should also be understood that terminology employed herein is used for the purpose of describing particular embodiments only and is not intended to be limiting.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/m L” should also be understood to provide support for the range of “50 mg/mL to 80 mg/mL” The endpoint may also be based on the variability allowed by an appropriate regulatory body, such as the FDA, USP, etc.

As used herein, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

### I. Pellet Grill Attachment

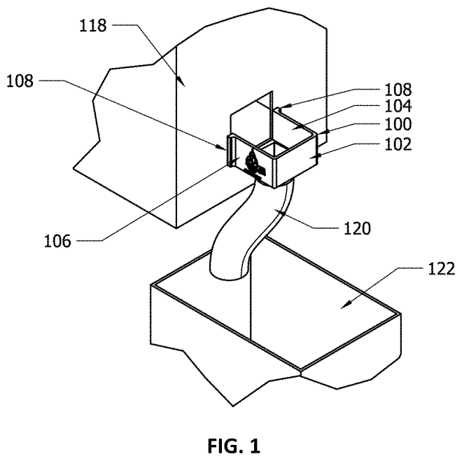

Described herein is a pellet grill attachment that is useful for funneling pellets from a pellet grill hopper into a storage container, thereby minimizing the number of pellets lost when removing pellets from the pellet hopper. In some embodiments, as seen in FIGS. 1-6, the pellet grill attachment 100 includes a front wall panel 102, a left wall panel 104, a right wall panel 106, and a bottom panel 112 that includes an aperture 114. The right and left wall panels each include a flange end 108. The flange ends 108 include a flange extending outward from the wall panel and an attachment mechanism 110 that is operable to attach to a pellet grill hopper 118.

In some embodiments, the pellet grill attachment 100 may comprise plastic, metal, wood, ceramic, composite, resin, or combinations thereof. In some aspects, the pellet grill attachment 100 may be 3D-printed. In some aspects, the pellet grill attachment 100 comprises polyethylene terephthalate glycol, polyethylene terephthalate, polystyrene, polyastic acid, acrylonitrile butadiene styrene, polylactic acid, polyvinyl alcohol plastic, polycarbonate, polyamide, alum ide, or combinations thereof. In one example, the pellet grill attachment 100 comprises polyethylene terephthalate glycol (PETG). Each of the front wall panel 102, left wall panel 104, right wall panel 106, and bottom panel 112 may comprise the same materials, or each may comprise a different material.

The front wall panel 102 acts as a barrier to control the movement of pellets as they exit the pellet grill hopper 118. When pellets exiting the pellet grill hopper 118 contact the front wall panel 102, they are deflected backward toward the aperture 114 of the bottom panel 112. The front wall panel 102 includes a left end, a right end, and a bottom end. The left end of the front wall panel 102 is attached to the left wall panel 104. The right end of the front wall panel 102 is attached to the right wall panel 106. In some aspects, the attachments may be reversible or permanent. In some aspects, the attachment is reversible and may include magnets, screws, adhesives, pins, hook and loop fasteners, hooks, double sided tape, or other reversible attachments known in the art. In some aspects, the attachment is permanent and may include adhesives, nails, screws, welding, or other permanent attachments known in the art. In some examples, the front wall panel 102, the left wall panel 104, and the right wall panel 106 are seamlessly attached; stated another way, the front wall panel 102, the left wall panel 104, and the right wall panel 106 may be a single piece.

In some embodiments, the front wall panel 102 may have a length of about 4.750 to about 6.000 inches. In some aspects, the front wall panel may have a length of about 4.750 inches, about 5.000 inches, about 5.250 inches, about 5.500 inches, about 5.750 inches, or about 6.000 inches. In some additional aspects, the front wall panel may have a length of about 4.750 to about 5.000 inches, about 5.000 inches to about 5.250 inches, about 5.250 inches to about 5.500 inches, about 5.500 inches to about 5.750 inches, or about 5.750 inches to about 6.000 inches. In one example, the front wall panel has a length of about 5.250 inches. In some additional embodiments, the front wall panel may have a height of about 3.000 inches. In yet other embodiments, the front wall panel may have a thickness of about 0.250 inches.

The left wall panel 104 acts as another barrier to control the movement of pellets as they exit the pellet grill hopper 118. The left wall panel includes a front end, a flange end 108 that is opposite the front end, and a bottom end, wherein the front end of the left wall panel is attached to the left end of the front wall panel 102. The flange end 108 of the left wall panel includes a flange extending outward form the left wall panel and an attachment mechanism 110 operable to reversibly or permanently attach the flange to the pellet grill hopper 118. In some aspects, the flange may extend outward from the left wall panel at an angle of 90°, at an angle less than 90°, or at an angle greater than 90°.

In some embodiments, the left wall panel 104 may have a length of about 4.750 to about 6.000 inches. In some aspects, the left wall panel may have a length of about 4.750 inches, about 5.000 inches, about 5.250 inches, about 5.500 inches, about 5.750 inches, or about 6.000 inches. In some additional aspects, the left wall panel may have a length of about 4.750 to about 5.000 inches, about 5.000 inches to about 5.250 inches, about 5.250 inches to about 5.500 inches, about 5.500 inches to about 5.750 inches, or about 5.750 inches to about 6.000 inches. In one example, the left wall panel has a length of about 5.250 inches. In some additional embodiments, the left wall panel may have a height of about 3.000 inches. In yet other embodiments, the left wall panel may have a thickness of about 0.250 inches.

The right wall panel 106 acts as yet another barrier to control the movement of pellets as they exit the pellet grill hopper 118. The right wall panel 106 includes a front end, a flange end 108 that is opposite the front end, and a bottom end, wherein the front end of the right wall panel 106 is attached to the right end of the front wall panel 102. The flange end of the right wall panel 106 includes a flange extending outward form the right wall panel 106 and an attachment mechanism operable to reversibly or permanently attach the flange to the pellet grill hopper 118. In some aspects, the flange may extend outward from the left wall panel at an angle of 90°, at an angle less than 90°, or at an angle greater than 90°.

In some embodiments, the right wall panel 106 may have a length of about 4.750 to about 6.000 inches. In some aspects, the right wall panel 106 may have a length of about 4.750 inches, about 5.000 inches, about 5.250 inches, about 5.500 inches, about 5.750 inches, or about 6.000 inches. In some additional aspects, the right wall panel 106 may have a length of about 4.750 to about 5.000 inches, about 5.000 inches to about 5.250 inches, about 5.250 inches to about 5.500 inches, about 5.500 inches to about 5.750 inches, or about 5.750 inches to about 6.000 inches. In one example, the right wall panel 106 has a length of about 5.250 inches. In some additional embodiments, the right wall panel 106 may have a height of about 3.000 inches. In yet other embodiments, the right wall panel 106 may have a thickness of about 0.250 inches.

In some embodiments, the flanges of the left wall panel 104 and the right wall panel 106 may each have a height of about 3.000 inches. In some embodiments the flanges may each have a width of about 0.625 inches.

In some embodiments, the attachment mechanism of the flanges of the left wall panel 104 and right wall panel 106 may be operable to reversibly attach to a pellet grill hopper 118. In some aspects the attachment mechanism may include at least one magnet, at least one screw, double-sided tape, at least one pin, hook and loop fasteners, hooks, adhesives, or any combination thereof or through any other reversible attachment mechanisms known in the art. In some examples, the attachment mechanism is at least one magnet. In some additional examples, the flanges may each include a slot to house the attachment mechanism.

In some additional embodiments, the attachment mechanism of the flanges of the left wall panel 104 and the right wall panel 106 may be operable to permanently attach to a pellet grill hopper 118. In some aspects, the attachment mechanism may include least one nail, welding, adhesive, or any combination thereof or through any other permanent attachment mechanisms known in the art. In some examples, the pellet grill attachment 100 may be seamlessly attached to the pellet grill hopper 118; stated another way, the pellet grill attachment and the pellet hopper 118 may be a single, uniform piece.

The bottom panel 112 acts as another barrier to control the movement of pellets as they exit the pellet grill hopper 118. The bottom panel 112 includes an aperture 114, which directs the flow of pellets exiting the pellet grill hopper 118. The aperture 114 may be in the shape of a circle, a square, a rectangle, a triangle, a pentagon, a hexagon, or another polygon. The aperture 114 may be large enough to allow pellets exiting the pellet grill hopper 118 to pass through the aperture easily without clogging. Thus, the aperture size may be variable based on the size and number of pellets. In one example, the aperture is circular and has a diameter of about 3 inches.

The bottom panel 112 is attached to the bottom ends of the front wall panel 102, the left wall panel 104, and the right wall panel 106. In some embodiments, the bottom panel 112 may be attached to the bottom ends of the front wall panel 102, the left wall panel 104, and the right wall panel 106 by adhesives, nails, staples, magnets, hook and loop fasteners, welding, screws, hooks, pins, or other methods of attachment known in the art. In other embodiments, the bottom panel 112 may be seamlessly attached to the bottom ends of the front wall panel 102, the left wall panel 104, and the right wall panel 106; stated another way, the bottom panel 112, the front wall panel 102, the left wall panel 104, and the right wall panel 106 may be a single piece.

In some embodiments, the aperture 114 of the bottom panel 112 may have an inner diameter of about 3.000 inches and an outer diameter of about 3.125 inches. In some aspects, the aperture 114 of the bottom panel 112 may extend downward. In some additional aspects, the aperture may be operable to reversibly or permanently attach to a chute. In some examples, the aperture 114 may have a length of about 0.500 inches to about 0.750 inches. In some aspects, the aperture 114 may be operable to reversibly or permanently attach to a chute 120.

In some aspects, the bottom panel 112 may include sloped edges that guide the pellets exiting the pellet grill hopper 118 to the aperture 114. In some additional aspects, the bottom panel 112 may include flat edges. In some examples when the bottom panel 112 has sloped edges, the edges may be sloped at an angle such that the aperture 114 is located 1.000 inches below the bottom ends of the front wall panel, the left wall panel, and the right wall panel.

In some embodiments, the pellet grill attachment 100 of the present disclosure may further comprise a chute 120. The chute 120 allows a user to more precisely control the flow of pellets exiting the pellet grill hopper 118. In some embodiments, the chute 120 may permanently or reversibly attach to the bottom panel 112 and act as an extension to the aperture 114 of the bottom panel 112. In some embodiments, the cross-section of the chute 120 may be the same shape as the aperture 114. In some additional aspects, the chute 120 may comprise plastic, metal, wood, composite, ceramic, paper, foil, or combinations thereof. In one example, the chute 120 comprises a dryer vent hose. In some examples, the chute may comprise aluminum or polyvinylchloride. In some aspects, the chute 120 may be rigid or flexible. In some examples, the chute 120 may stretch and/or contract, allowing a user to precisely control the flow of pellets exiting the pellet grill hopper 118. In some embodiments, the chute 112 may be seamlessly connected to the aperture 114; stated another way, the chute and the aperture may form a single piece. In one example, the chute is about 5 inches long._In some aspects, the chute may bend near the bottom to form a curved edge to further direct the flow of pellets. In some additional aspects, the chute may be retractable. In some embodiments, the chute may form a friction fit with the aperture of the bottom panel.

FIG. 1 shows a pellet grill attachment 100 attached to a pellet grill hopper 118. A storage container 122 is shown below the pellet grill hopper. A flexible chute 120 is attached to the pellet grill attachment 100 and positioned above the storage container 122.

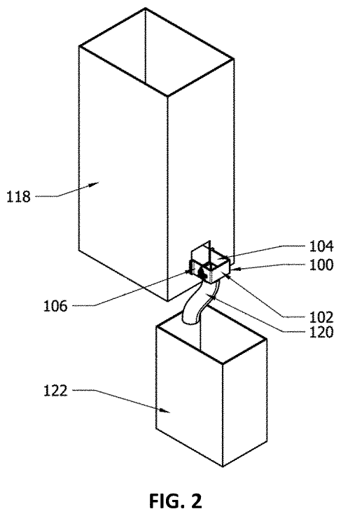

FIG. 2 is a zoomed-out view of FIG. 1, and shows the position of the storage container 122 in relation to the pellet grill hopper 118.

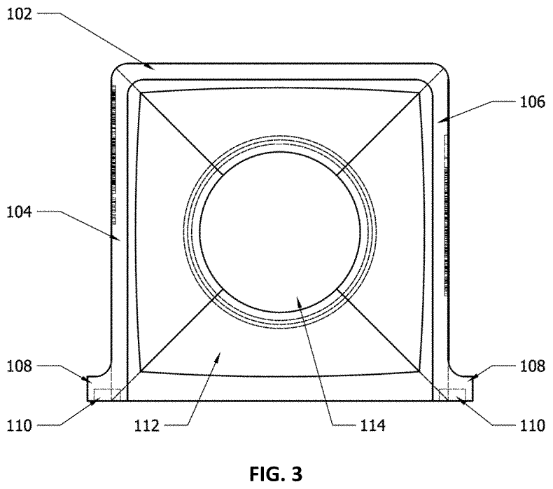

FIG. 3 shows a top-side view of the pellet grill attachment 100. The aperture 114 of the bottom panel 112 is shown at the center of the pellet grill attachment. The two flanges 108 on the left wall panel 104 and the right wall panel 106 contain a slot to house an attachment mechanism 110. The embodiment of FIG. 3 shows that the left wall panel 104, the right wall panel 106, and the front wall panel 102 are all seamlessly connected.

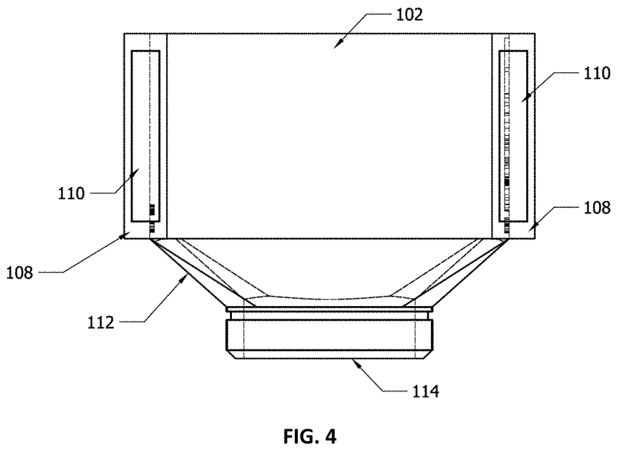

FIG. 4 shows a front-facing view of the pellet grill attachment 100, wherein the flanges 108 are toward the front of the image. As can be seen from the figure, the bottom panel 112 includes sloped edges. The aperture 114 extends downward and is operable to attach to a chute.

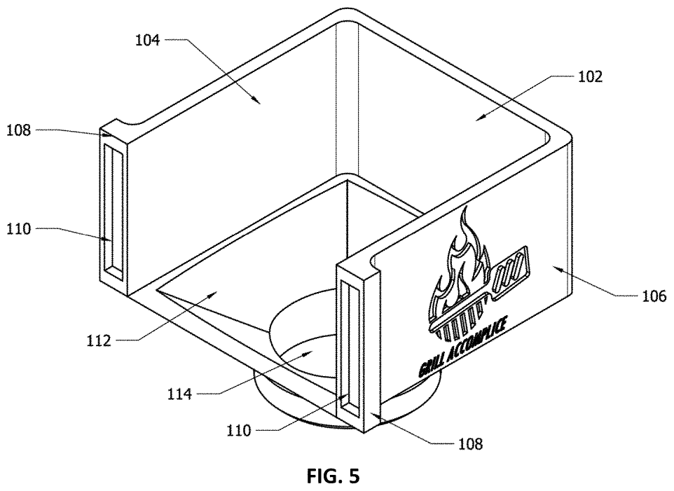

FIG. 5 shows a perspective view of the pellet grill attachment 100 with the flange 108 of the right side wall panel 106 at the front of the image. Again, slots are included to house an attachment mechanism 110 and can be seen on the flanges 108.

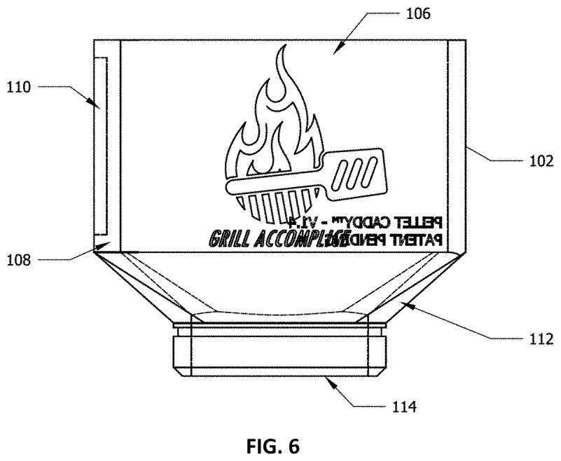

FIG. 6 shows a side-view of the pellet grill attachment 100 with the right side wall panel 106 at the front of the image.

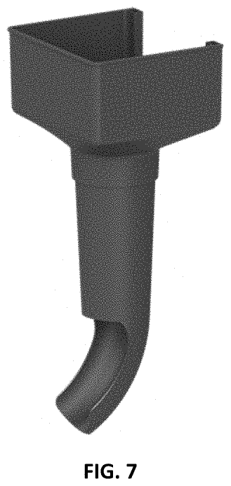

FIG. 7 shows a view of the pellet grill attachment with a curved chute. The bottom of the chute is curved to better direct the flow of pellets into a storage container.

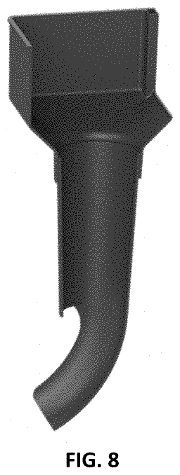

FIG. 8 shows a full cutaway view of the pellet grill attachment with a curved chute. As can be seen form the image, the sloped edges of the bottom panel help to direct the flow of pellets into the chute and then into a storage container.

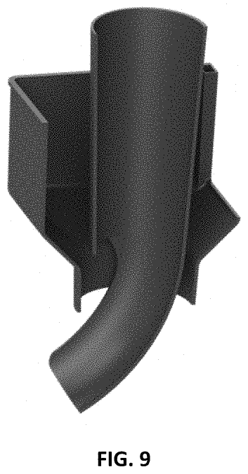

FIG. 9 shows a cutaway view of the pellet grill attachment with a curved chute, wherein the chute is in a retracted position. The retractable chute increases the portability of the pellet grill attachment and reduces storage space.

### II. Methods

Further disclosed herein are methods for removing pellets from a pellet grill hopper. The method includes providing a pellet grill hopper. In some embodiments, the pellet grill hopper may include a clean-out door or cover that is used to remove pellets from the pellet grill hopper by gravity. In one example, the clean-out door may include a hinged piece that covers an opening in the pellet grill hopper. When the hinged piece is opened, the pellets within the hopper may fall out of the hopper through the door by gravity.

The method further includes attaching a pellet grill attachment described in Section I above to the pellet grill hopper. In some embodiments, the pellet grill attachment may be reversibly attached to the pellet grill hopper. In some aspects, the pellet grill attachment may be reversibly attached to the pellet grill hopper by using at least one magnet, at least one screw, double-sided tape, at least one pin, hook and loop fasteners, hooks, adhesives, or any combination thereof or through any other reversible attachment mechanisms known in the art. In some examples, the attachment mechanism is at least one magnet.

In some embodiments, the pellet grill attachment 100 may be permanently attached to the pellet grill hopper. In some aspects, the pellet grill attachment may be permanently attached by using at least one nail, adhesives, welding, or combinations thereof or through any other permanent attachment mechanisms known in the art.

The method may further include positioning a storage container below the pellet grill attachment. In some aspects, the storage container may include a bag, box, jar, drum, barrel, bucket, sack, or any other storage container known in the art. In some examples, the storage container may be weatherproof to prevent excess moisture from contacting and absorbing into the pellets during storage. The storage container may be positioned below the pellet grill attachment so that pellets exiting the pellet grill hopper flow into the storage container. If the pellet grill attachment includes a chute, the chute may additionally be inserted into the storage container to ensure that the pellets flow into the storage container.

Last, the method may further include opening the clean-out door of the pellet grill hopper once the pellet grill attachment is attached and the storage container has been placed. Once the clean-out door has been opened, the pellets within the pellet grill hopper will fall out of the hopper and will flow through the pellet grill attachment into the storage container, thus controlling the flow of the pellets and minimizing the number of pellets that drop to the floor.

### EXAMPLES

A pellet grill attachment of the present disclosure was printed using a Creality Ender Pro 3 3D printer. The front wall panel, left wall panel, right wall panel, and bottom panel were all printed using the 3D printer and all formed a single, seamless piece. The printing material used was polyethylene terephthalate glycol. The front wall panel, right wall panel 106, and left wall panel each had a height of about 3.000 inches, a length of about 5.250 inches, and a thickness of about 0.250 inches.

The bottom panel had a length of about 4.750 inches and included sloped edges. The aperture of the bottom panel was located about 1.000 inches below the bottom ends of the front wall panel, the right wall panel, and the left wall panel. The aperture of the bottom panel had an inner diameter of about 3.000 inches and an outer diameter of about 3.125 inches. The aperture had a length of about 0.750 inches.

The flanges of the left wall panel and the right wall panel each had a height of about 3.000 inches and a width of about 0.625 inches. Each flange included a slot to house a magnet. The slot had a height of about 2.350 inches and a width of about 0.410 inches.

Rare earth magnets were placed in the housing located on the flange. The magnets were 60 mm×10 mm×5 mm in size.

A chute was provided that could be reversibly attached to the aperture of the bottom panel. The chute was made from a dryer vent hose and was cut down to size.

What is claimed is:

1. A pellet grill attachment comprising:
a front wall panel comprising a left end, a right end, and a bottom end;
a left wall panel comprising a front end, a flange end that is opposite the front end, and a bottom end, wherein the front end of the left wall panel is attached to the left end of the front wall panel;
a right wall panel comprising a front end, a flange end that is opposite the front end, and a bottom end, wherein the front end of the right wall panel is attached to the right end of the front wall panel; and
a bottom panel comprising an aperture, wherein the bottom panel is attached to each of the bottom ends of the front wall panel, the left wall panel, and the right wall panel,
wherein each of the flange ends of the left wall panel and the right wall panel comprises:
a flange extending outward from the wall panel; and
an attachment mechanism that is operable to attach to a pellet grill hopper.

2. The pellet grill attachment of claim 1, wherein the pellet grill attachment is 3D-printed or injection molded.

3. The pellet grill attachment of claim 1, wherein the bottom panel further comprises sloped edges.

4. The pellet grill attachment of claim 1, wherein the attachment mechanism is operable to reversibly attach to the pellet grill hopper.

5. The pellet grill attachment of claim 4, wherein the attachment mechanism comprises at least one screw, at least one magnet, double-sided tape, at least one pin, hook and loop fasteners, hooks, adhesives, or any combination thereof.

6. The pellet grill attachment of claim 5, wherein the attachment mechanism is at least one magnet.

7. The pellet grill attachment of claim 1, wherein the attachment mechanism is operable to permanently attach to the pellet grill hopper.

8. The pellet grill attachment of claim 7, wherein the attachment mechanism is at least one nail, welding, adhesive, or any combination thereof.

9. The pellet grill attachment of claim 1, further comprising a chute, wherein the chute is attached to the aperture of the bottom panel.

10. The pellet grill attachment of claim 9, wherein the chute comprises plastic or metal.

11. The pellet grill attachment of claim 1, wherein the front wall panel, the left wall panel, the right wall panel, and the bottom panel further comprise plastic, metal, wood, ceramic, composite, or a combination thereof.

12. The pellet grill attachment of claim 11, wherein the front wall panel, the left wall panel, the right wall panel, and the bottom panel each further comprise plastic.

13. The pellet grill attachment of claim 1, wherein the flanges of each of the left wall panel and the right wall panel extend perpendicularly outward from the wall panel.

14. A method for removing pellets from a pellet grill hopper, the method comprising:
providing a pellet grill hopper with pellets;
attaching a pellet grill attachment of claim 1 to the pellet grill hopper at a location where pellets may exit the pellet grill hopper;
positioning a storage container below the pellet grill attachment;
releasing the pellets contained in the pellet grill hopper.

15. The method of claim 14, wherein the pellet grill hopper further comprises a clean-out door.

16. The method of claim 15, wherein the pellet grill attachment is attached below the clean-out door.
